(19) United States
(12) Patent Application Publication
(10) Pub. No.: US 2017/0094944 A1
(43) Pub. Date: Apr. 6, 2017

(54) Dog Toy Including Compartment for Removable Inserts

(71) Applicants: Timothy Knight, Spotsylvania, VA (US); Alejandro Lara, Fredericksburg, VA (US)

(72) Inventors: Timothy Knight, Spotsylvania, VA (US); Alejandro Lara, Fredericksburg, VA (US)

(21) Appl. No.: 14/756,697

(22) Filed: Oct. 2, 2015

(51) Int. Cl. A01K 15/02

(52) U.S. Cl. CPC A01K 15/026

(57) ABSTRACT

A toy for a domestic animal comprises a deformable outer shell defining an interior compartment, wherein the outer shell surrounds a hollow interior compartment that includes an integral opening. A tab closure to limits the size of the opening, and removable inserts are located within the compartment, which the domestic animal can remove. The act of removing the inserts induces a pleasurable response in the domestic animal as the inserts are removed.

### CROSS REFERENCE TO RELATED APPLICATIONS

None

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION-BY-REFERENCE OF MATERIAL SUBMITTED ON A COMPACT DISK

None

### BACKGROUND OF THE INVENTION

Pet toys that dispense edible and non-edible treat are well known in the art. U.S. Pat. No. 5,832,877 issued Nov. 10, 1998 to Joseph P. Markham shows an elongated elastomeric pet toy that includes a longitudinal panel with first and second lips formed along opposite respective longitudinal edges of the panel. These edges are folded over to form respective bights that serve as deformable hollow shape-retaining receptacles for receiving an animal treat. The lip forms a longitudinal slit along the panel through which the treat can be inserted in the respective receptacles. When the animal chews on the pet toy, the treats will be forced out through the longitudinal slit so that the animal can eat them. Also, the receptacles may have open ends through which the treats can be inserted by a person and dispensed from the toy by the animal chewing on the toy. In one embodiment, the lips are folded over on the same side of the longitudinal panel to create bights that form adjacent receptacles. In another embodiment, the lips are folded on opposite sides of the longitudinal panel to create bights that form receptacles on opposite sides of the panel.

U.S. Pat. No. 6,941,895 issued Sep. 13, 2005 to Tracy Marie St. Pierre discloses a module for dispensing treats to a chewing animal has a hollow treat holder that has at least one aperture through which a treat can be inserted by a person or removed by a chewing animal and at least one end that can be removably attached to an end of another of said modules. The treat holder preferably has two ends, a male end and a female end, where the said male end locks into the female end and there is a treat barrier recessed into the ends. The hollow treat holder may have a variety of shapes such as straight, triangular, U-shaped, spheroidal, cubic, and L-shaped. A single module can be used as a treat-dispensing toy or a number of modules can be assembled together to form a larger treat-dispensing toy.

U.S. Pat. No. 6,983,722 issued Jan. 10, 2006 to Jacob Tepper et al. shows a pet treat dispensing system comprising a non-edible, interactive pet toy. Fastening means are provided therein for removably mounting and retaining an edible pet treat in an exposed position for easy access by a pet. The treat is kept at a distance from stainable surfaces when the toy i, in the upright position.

U.S. Pat. No. 7,032,541 issued Apr. 25, 2006 to Steven Tsengas discloses a pet chew toy for holding consumable treats comprises a body member having a plurality or ribs and a plurality of interstitial spaces formed between the ribs. The ribs and spaces cooperatively act to impinge a treat or treats inserted therein. The ribs and spaces may be disposed substantially parallel to the direction of the bore and a central axis, or may be disposed helically about the bore. The bore may be enclosed at one or both ends by threaded caps, heat bonded caps, or a combination thereof. A sound module may be provided within the bore for emitting a prerecorded or mechanically generated sound upon activation of the sound module.

U.S. Pat. No. 7,600,488 issued on Oct. 13, 2009 to Charles D. Mann discloses a non-consumable pet toy that includes a body having a first treat-retaining cavity and a first opening that extends between the first treat-retaining cavity and an outer surface of the body. The non-consumable pet toy also includes a metering device in the first opening that dispenses treats from the first treat-retaining cavity through the first opening at a metered rate. The first treat-retaining cavity is refillable through the metering device.

U.S. Pat. No. 9,004,012 issued Apr. 14, 2015 to Dale Taylor shows a reusable pet chew toy made of hard rubber and rawhide laces with a compartment to accommodate treats. The pet must chew through rawhide laces to break open the compartment to obtain the treat.

### BRIEF SUMMARY OF THE INVENTION

A toy for domestic animals is disclosed that dispenses edible or non-edible items that are held in a compartment within the toy. The compartment is refillable by the animal owner. In one embodiment, the non-edible items are tethered to the interior of the refillable compartment. The toy can assume various shapes and sizes, including animal shapes such as a puppy, or a bear, or non-animal shapes such as a fire hydrant or the like.

### BRIEF DESCRIPTION OF THE VARIOUS FIGURES

FIG. 1 shows a three-dimensional view of a stuffed animal toy with an interior compartment or pouch and entrails within the pouch.

FIG. 2 shows a three-dimensional view of a stuffed animal toy with an interior compartment or pouch wherein the entrails or removable inserts extend from the pouch.

FIG. 3 shows a sectional view with entrails within the pouch or compartment.

### BRIEF DESCRIPTION OF THE INVENTION

A toy for a domestic animal comprises a deformable outer shell defining an interior compartment, wherein the outer shell surrounds a hollow interior compartment that includes an integral opening. A tab closure limits the size of the opening; and removable inserts are located within the compartment that the domestic animal can remove. The act of removing the inserts induces a pleasurable response in the domestic animal as the inserts are removed.

### DETAILED DESCRIPTION OF THE INVENTION

The invention is best described in relation to the various figures.

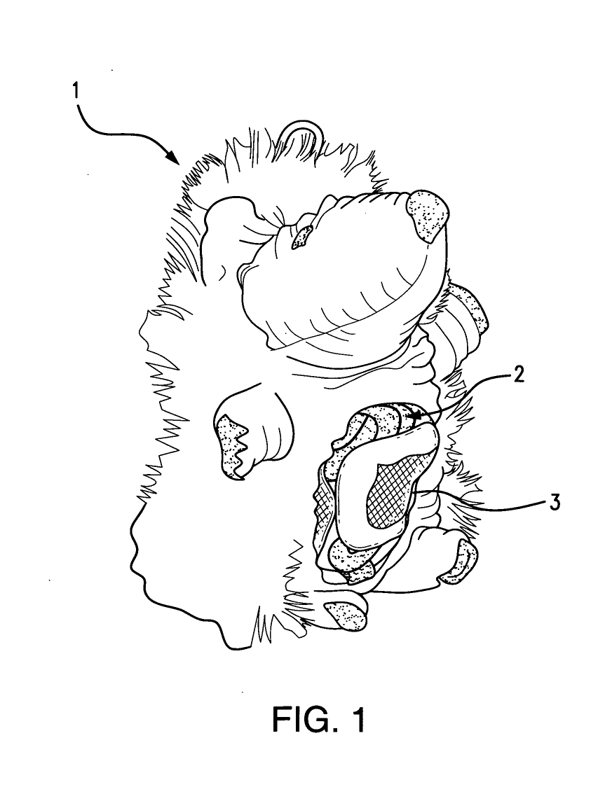

FIG. 1 depicts a stuffed toy (1), in this case a puppy, in three-dimensions. Although a puppy is shown herein, it is expressly understood that the invention is not limited to any given animal or non-animal shape. For instance, the stuffed toy could represent a bear, fireplug, or any suitable shape or image. The toy could be made from fabric, natural or synthetic, woven or non-woven, and have a flocked or smooth surface.

The interior of the stuffed toy is accessible from the exterior through opening (2), made integral with the stuffed toy. Pouch or compartment (3) contains entrails or inserts (4). Entrails (4) could be made from fabric, or an elastomeric material such as synthetic or natural rubber. In one embodiment, the entrails (4) are attached to the inside of the pouch by tether (5), to prevent loss of the entrail inserts after the entrails have been removed by the dog. Tab (6) is integrally attached to juxtaposing sides of opening (2) to limit the size of opening (2). In this manner, the domestic animal is unable to access all the entrails immediately, thereby delaying gratification and prolonging the pleasure response. Tab (6) could be stitched permanently to the periphery of opening (2). Alternatively tab (6) could be removable and attached to the periphery of opening (2), on one or both sides of opening (2) by buttons or micro hook and loop fasteners, such as Velcro®.

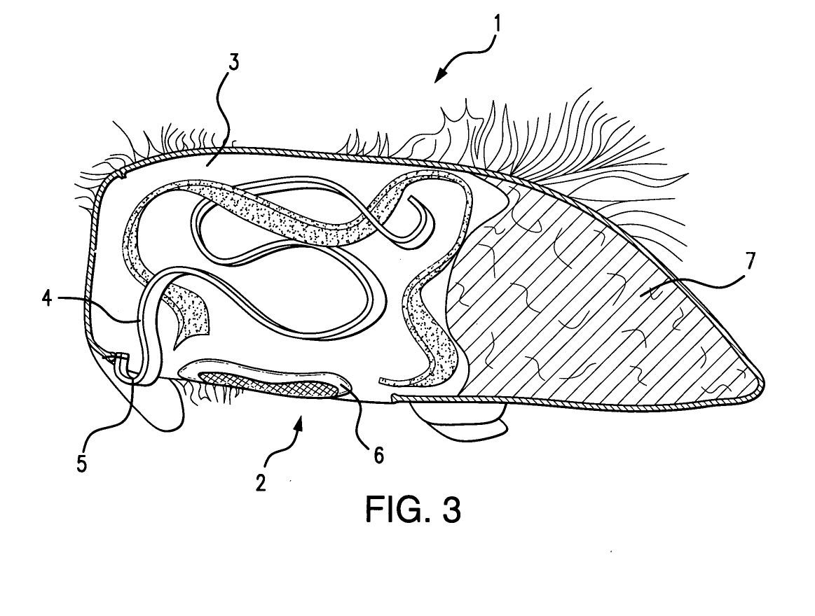

Aside from the interior of compartment or pouch (2), the toy can be stuffed with a deformable material (7) such as wool stuffing, as best seen in FIG. 3. All materials used in the invention must be non-toxic to prevent poisoning should the domestic animal consume all or part of the toy (1) and entrails (4). The exact material for the stuffing is non-critical, so long as the stuffing is non-toxic.

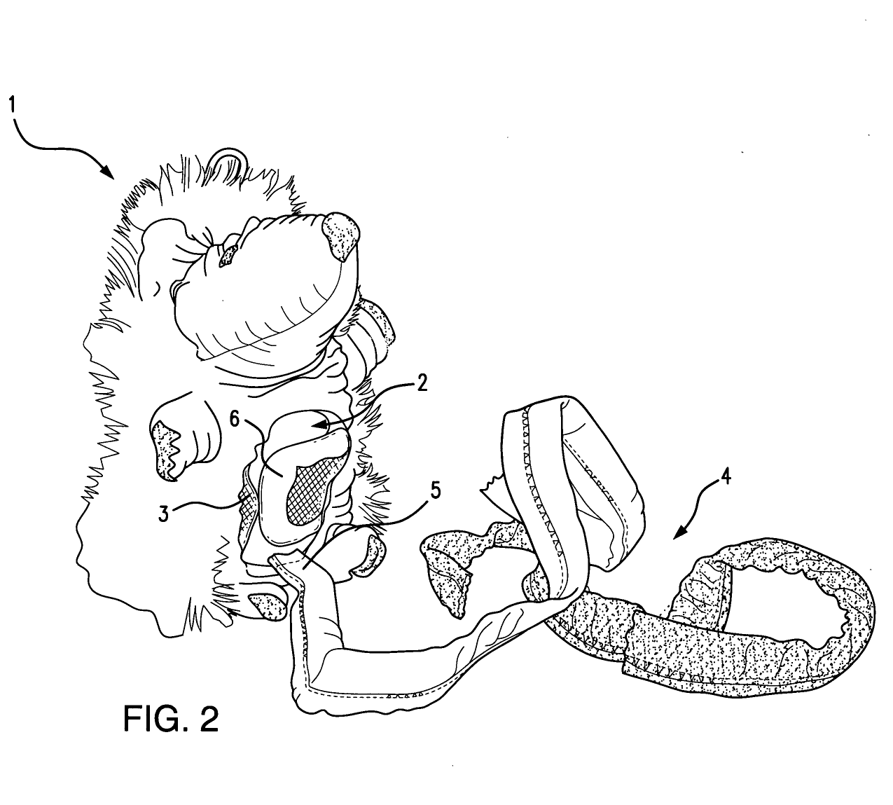

FIG. 2 shows entrails (4) extending from pouch (2) as the entrails would appear after the domestic animal has removed the entrails from the interior of pouch (2). The entrails are attached to the interior of pouch (2) with tether (5). Because the entrails (4) are tethered to the toy, their loss after the domestic animal has removed the entrails (4) is prevented. It is expressly understood that the entrails (4) may be tethered, untethered, or partially tethered. However, when the entrails (4) are edible, they normally are not attached to the toy.

FIG. 3 shows a sectional view of the stuffed toy according to the invention. The entrails (4) are shown within the pouch or compartment (2) of the stuffed toy. Wool-like stuffing (7) is seen in section.

In use, the interior compartment of the toy is filled with items of interest to the domestic animal, such as non-edible elastomeric inserts or edible treats. The size of the opening can be adjusted to accommodate animals of varies sizes and nose shapes. For instance, with a small dog or a dog with a long narrow snout, the opening (2) would necessarily be small. For a large dog with a wide snout, the opening (2) would need to be made wider. The size of the opening also regulates the amount of time required for the domestic animal to remove all the contents of compartment (2), thereby regulating the duration of gratification by the domestic animal.

When non-edible inserts (4) are used, the inserts (4) may optionally be attached to the interior of compartment (2) with tether (5). After the domestic animal has removed all the inserts (4), the human need only stuff the inserts back into the pet toy for another use.

1. A toy for a domestic animal, comprising a deformable outer shell defining an interior compartment, wherein the outer shell surrounds a hollow interior compartment that includes an integral opening with a tab closure to limit the size of the opening, and at least one removable insert within the compartment which the domestic animal can remove, thereby inducing a pleasurable response in the domestic animal as the inserts are removed.

2. The toy of claim 1 wherein the insert is tethered to an inside surface of the hollow interior compartment, whereby the insert remains attached to the toy after the domestic animal has removed the insert.

3. The toy of claim 1 wherein the insert is unattached to the inside surface of the hollow interior compartment.

4. The toy of claim 1 wherein the interior compartment of the toy is filled with items of interest to the domestic animal, such as non-edible elastomeric inserts.

5. The toy of claim 1 wherein the interior compartment of the toy is filled with items of interest to the domestic animal, such as edible inserts.

6. The toy of claim 1 wherein the size of the integral opening can be adjusted to accommodate animals of varies sizes and nose shapes, and whereby the size of the integral opening also regulates the amount of time required for the domestic animal to remove all the contents of interior compartment, thereby regulating the duration of gratification by the domestic animal.

7. The toy of claim 6 wherein the tab is stitched permanently to the periphery of interior opening.

8. The toy of claim 6 wherein the tab is removable and attached to the periphery of interior opening on one or both sides of the interior opening by buttons.

9. The toy of claim 6 wherein the tab is removable and attached to the periphery of interior opening on one or both sides of the interior opening by micro hook and loop fasteners.
